(19) United States
(12) Patent Application Publication
(10) Pub. No.: US 2010/0196070 A1
(43) Pub. Date: Aug. 5, 2010

(54) METHOD, APPARATUS AND SYSTEM FOR MEDIA REGISTRATION SETUP USING A DEVELOPED IMAGE PATCH

(75) Inventors: Robert A. GROSS, Penfield, NY (US); David AHL, Rochester, NY (US)

Correspondence Address: OLIFF & BERRIDGE, PLC., P.O. BOX 320850, ALEXANDRIA, VA, 22320-4850, US

(73) Assignee: Xerox Corporation, Norwalk, CT (US)

(21) Appl. No.: 12/363,908

(22) Filed: Feb. 2, 2009

(51) Int. Cl. G03G 15/00

(52) U.S. Cl. 399/394

(57) ABSTRACT

A method, apparatus and system for media registration setup, includes depositing developed image toner patch on a photoreceptor surface, such that the developed image patch overlaps two image panels on the photoreceptor surface. Performing toner image transfer on a media sheet in contact with the photoreceptor by applying electrostatic field to cause toner particles to migrate from the photoreceptor surface to the media. Following toner image transfer, the level of residual toner on the photoreceptor surfaces measured by sensors to determine alignment of a written lead edge and a target lead edge, the written lead edge corresponding to the lead edge of the media. The measurements are used to adjust the media registration setup such that the written lead edge corresponds to a given target lead edge.

### BACKGROUND

The exemplary embodiments are directed to a method, apparatus and system for media registration setup using a developed image patch. More specifically, the exemplary embodiments are directed to a method, apparatus and system for media registration setup using a developed image patch and sensors that detect toner area coverage on a photoreceptor belt.

The electrostatic imaging and printing processes are comprised of several distinct stages. These stages may generally be described as (1) charging, (2) imaging, (3) exposing, (4) developing, (5) transferring, (6) fusing and (7) cleaning. In the charging stage, a uniform electrical charge is deposited on a charge retentive surface, such as, for example, a surface of a photoreceptor, so as to electrostatically sensitize the surface.

Imaging converts an original or digital image into a projected image on the surface of the photoreceptor and the image is then exposed upon the sensitized photoreceptor surface. An electrostatic latent image is thus recorded on the photoreceptor surface corresponding to the original image, or digital image.

Development of the electrostatic latent image occurs when charged toner particles are brought into contact with this electrostatic latent image. The charged toner particles will be attracted to either the charge or discharge regions of the photoreceptor surface that corresponds to the electrostatic latent image, depending on whether a charged area development (CAD) or discharged area development (DAD, more common) is being employed.

In the case of a single step transfer process, the photoreceptor surface with the electrostatically attracted toner particles is then brought into contact with an image receiving surface, i.e., media paper or other similar substrate. The toner particles are imparted to the image receiving surface by an image transferring process wherein an electrostatic field attracts the toner particles toward the image receiving surface, causing the toner particles to adhere to the image receiving surface rather than to the photoreceptor. The toner particles then fuse into the image receiving surface by a process of melting and/or pressing. The process is completed when the remaining toner particles are removed or cleaned from their photoreceptor surface.

The photoreceptor surface may be divided into one or more image panels. To ensure that media, such as, for example, paper, is properly registered to receive an aligned image by the transfer process from an image panel of the photoreceptor, various methods are known in the art. For example traditionally, a crosshair image is programmed near the lead edge and on the trail edge of the image panel of the photoreceptor. Paper is carried by a transfer belt through the transfer region created by the photoreceptor and the transfer belt, and the alignment of the crosshairs relative to the edge of the paper is measured. If misaligned, parameters such as the ride dynamics, e.g., the original philosophy or the on-time, may affect the timing of when the paper contacts the photoreceptor by advancing or delaying the timing, or changing the timing relative to performing an edge registration.

This process is generally performed by a person, e.g., a technician. If the system determines that the image panel with an electronic image senses a gap between the top edge and lead edge relative to the exact gap location of, for example, 10 millimeters, the technician must program an electronic document, run paper transfer, measure, and change non-volatile memory “NVM” controls to make adjustments. The steps may then be repeated to achieve the desired registration. In other words, registration as commonly understood is not automatic. Instead, registration always requires a manual interpretation of where a registration is relative to the lead edge. The technician may step through various registration MVMs, and may read to pull out the MVM value that yields the best registration. That value is then input into software to set the registration timing. Alternatively, the sensors may be included in the printer sens the location of such crosshairs on the paper. This, however, involves substantial additional cost, and suffers from inaccuracies due to the difficulty in accurately positioning the sheet for measurement.

### SUMMARY

It would be advantageous to accommodate automatic registration to improve efficiency and ensure accurate and precise media registration in imaging systems. In particular, it would be advantageous to accommodate automatic sensing of misalignment of media paper and further automatic adjustment to properly align and register media paper for toner image transfer. In order to achieve automatic interpretation of where a registration is relative to the lead edge of an image panel on a photoreceptor, developed image patches are used.

To address these problems and accomplish the above-mentioned advantages among others, a method, apparatus and system are disclosed for media registration setup in an image recognition device using a developed image patch.

During development, toner is deposited on a photoreceptor or image transfer belt (for example, in intermediate transfer assemblies) on various image panels of a photoreceptor. As media paper contacts a photoreceptor, an electric field is applied. Application of the electric field assists in transferring the toner particles to the paper. Such processes generally yield 95% efficiency of toner particle migration to media.

Methods are disclosed herein for media registration setup using an image recognition device. For example, one method may include depositing a developed image patch on a photoreceptor. The photoreceptor may have a plurality of image panels arranged adjacent to one another. The developed image patch may include toner particles, and may be deposited so as to overlap two adjacent image panels, commencing in the space between the trail edge of one sheet and the lead edge of the next (“inter-document zone” or “IDZ”). Each image panel has a lead edge. A media sheet is carried to a transfer region, the transfer region being defined by the photoreceptor or intermediate transfer belt. The sheet has a sheet lead edge. An electric field may be applied to the media sheet to transfer toner particles of the toner image patch. Sensors may be used to sense the time from when the sensor detects the start of the patch to the time when the patch density is diminished due to most (e.g. 95%) of the toner being carried off by the sheet. Since the velocity of the belt is constant, this difference in time provides knowledge of the distance between the sheet arrival location and the beginning of the generated patch. The desired location of the media sheet may then be judged by determining a location of the written lead edge corresponding to the media sheet lead edge and relative to a target lead edge. In other words, measuring the time between the beginning of the patch and the start of the transferred portion of the patch and comparing this time to a nominal or target time allows the sheet timing to be altered such that the target time is achieved, i.e. the written lead edge is moved to the target lead edge. These automated timing adjustments may alter either the location of the image with respect to the image panel or the arrival location of the sheet lead edge with respect to the image panel. The target lead edge is the desired location of a particular media edge. Angular alignment of the media sheet lead edge may be determined by performing similar measurements in two locations, i.e. one nearer to the inboard edge of the sheet and one nearer to the outboard edge of the sheet. The existing system for skew correction may then be used to obtain the desired alignment. The methods disclosed are not restricted to lead edges, but may apply to side and trail edges.

The image recognition device may include sensors arranged about the photoreceptor for sensing a toner transfer efficiency. Sensors may detect black toner area concentration, or alternatively, detect different levels of toner concentration of varying colors, e.g., black, cyan, yellow or magenta. Often these sensors already exist in the machine to provide feedback for xerographic process controls; in such cases the proposed registration system would involve no additional hardware cost.

Exemplary embodiments are described herein with respect to methods, apparatus and systems for media registration setup and image recognition devices. However, it is envisioned that any systems that may incorporate the features of the methods, apparatus and systems described herein are encompassed by the scope and spirit of the exemplary embodiments.

### BRIEF DESCRIPTION OF THE DRAWINGS

FIG. 1 is diagrammatical view of an image recognition device in accordance with an exemplary embodiment;

FIG. 2 is a diagrammatical view of a developed image patch after toner transfer;

FIG. 3 is a flowchart showing a method of media registration in accordance with an exemplary embodiment.

### EMBODIMENTS

The exemplary embodiments are intended to cover all alternatives, modifications and equivalents as may be included within the spirit and scope of the methods, devices and systems as defined herein.

For an understanding of the method and system for media registration setup, reference is made to the drawings. In the drawings, like reference numerals have been used throughout to designate similar or identical elements. The drawings depict various embodiments of illustrative devices and systems for media registration setup incorporating the features of the exemplary embodiments therein. As shown, the drawings diagrammatically depict the methods and systems with various features. Inasmuch as the art of image recognition is well known, the methods, devices and systems are diagrammatically shown herein and described with reference thereto.

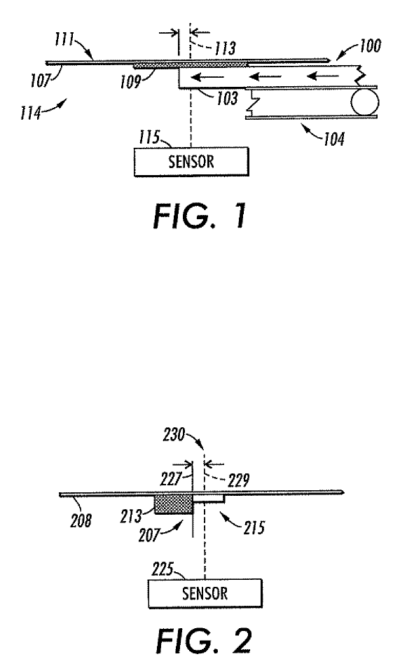

FIG. 1 shows an apparatus for media registration setup for registering media, such as, for example, a paper 100 having a paper lead edge 103 and carried by a transfer device, for example a media transfer belt 104. Photoreceptor surface 107 may include a plurality of image panels 111, each image panel 111 having an image panel lead edge 113. Image panels 111 may be directly adjacent to one another. The photoreceptor surface 107 may accommodate deposition during toner image development of a developed toner image patch 109.

A media transfer belt 104 may define with the photoreceptor surface 107 a transfer region 114. As the paper 100 is brought into contact with photoreceptor surface 107 in the transfer region 114, an electrostatic field may be applied to cause transfer of the toner particles of the developed image patch 109 from the photoreceptor surface 107 to the paper 100. Sensors 115 may be arranged in proximity to developed image patch 109 so that following transfer of toner particles from developed image patch 109 to paper 100, sensors 115 may sense the residual toner on photoreceptor surface 107 to determine transfer efficiency and measure the time between the start of the patch and the start of the transferred image, corresponding to the leading edge of the sheet.

Developed image patch 109 maybe deposited in a manner such that developed image patch 109 overlaps two adjacent image panels 111 on photoreceptor surface 107 such that a first portion of developed image patch 109 is deposited in front of an image panel lead edge, and a second portion of developed image patch 109 is deposited on a side of the image panel lead edge opposite the front position. Following toner particle transfer after application of the electrostatic field, a written lead edge may be defined by the residual image remaining on the photoreceptor surface 107 after image transfer. Specifically, an amount of toner residue following image transfer may be greater on an area of the developed image patch 109 that is in front of a paper lead edge 103 during toner image transfer, i.e., the portion of the developed image patch 109 that is not in contact with paper 100 during toner image transfer.

FIG. 2 shows the developed toner image patch following toner image transfer in accordance with an exemplary embodiment. Written lead edge 227 corresponds to a residual image border defined by the portion of the developed image patch 207 that is in contact with paper 100 unto the paper lead edge 103 of paper 100 during toner image transfer and during application of an electrostatic field in the transfer region. Following image transfer, the portion of developed image patch 207 that is in contact with paper 100 during transfer carries less residual toner than the portion not contacted by the paper, i.e. most (e.g. 95%) of the toner particles of the portion of developed image patch 207 that is in contact with paper 100 are transferred during toner image transfer leaving a lower density residual toner image than regions of developed image patch 207 that are not in contact with paper 100 during toner image transfer. FIG. 2 shows a high density residual image region 213 and a low density residual image region 215. The high density residual image region 213 is easily distinguishable from the low density residual image region 215. The transition between regions 213 and 215 defines a written lead edge 227.

Referring again to FIG. 1, FIG. 1 shows misregistration of the paper 100 if a target border corresponds to the image panel lead edge. For example, FIG. 2 shows a developed image patch 207 following toner image transfer wherein a target border 230 corresponds to an image panel lead edge 229. One or more sensors 225 may be used to determine a written lead edge 227 following a first toner image transfer process, and to further determine whether the written lead edge 227 corresponds to the target border 230. If the target border 230 and the written lead edge 227 are not aligned, the system may be adjusted to properly register the paper so as to cause alignment of the target border 230 and a written lead edge 227. The sensor 225 may, for example, have a high output, e.g. 4.5 volts, at bare portions of photoreceptor surface 208. The sensor 225 may output at a low level, e.g. 1 volt, at portions of the image patch 207 wherefrom there has been little or no toner transfer, and may output at a higher level, e.g. 4 volts at portions of image patch 207 wherefrom there has been a higher degree of toner transfer; only to reach a higher output, e.g. 4.5 volts as the image patch 207 passes the sensor 225 and the sensor again outputs to bare portions of the photoreceptor surface 208. This allows sensor 225 to determine the written lead edge 227, which may be located at the transition between portions of image patch 207 where the sensor output differs substantially. The timing of media sheet carriage may then be adjusted such that the written lead edge 227 corresponds with target border 230. The above allows for, among other advantages, automated registration by sensing black toner concentration or varying toner concentrations of a developed image patch following toner image transfer to determine the location of an edge of a paper in an image recognition device, and to adjust the paper if the edge of the paper is not aligned with a given target border. Although a paper lead edge is discussed in the figures, alignment with respect to a paper trail edge, and side edges are clearly within the scope of the methods, devices and systems discussed herein. Side edges may also be detected by measuring the width of a residual patch, i.e. by an array sensor.

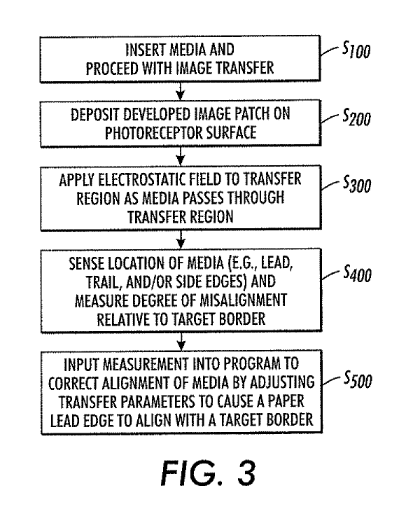

FIG. 3 shows an exemplary method in accordance with yet another embodiment. The method in accordance with an exemplary embodiment may include a media insertion step S100 whereby a paper media or other appropriate media may be inserted into an image recognition device and carried to a transfer region defined by a photoreceptor and a media transfer belt of an image transfer apparatus. During developed image patch deposition step S200, a developed image patch having toner particles may be deposited on the photoreceptor surface. The photoreceptor surface may include a plurality of image panels, and the image panels may be adjacent to one another. Deposited developed image patch may overlap two or more image panels.

As the media approaches, enters, and passes through the transfer region, an electrostatic field may be applied in toner image transfer step S300. Specifically, an electric field may be applied to cause toner particles to be attracted from the photoreceptor surface to the media. Following toner image transfer, the position of an edge of the paper may be measured during sensing step S400 by sensors. These sensors may be BTAC or ETAC sensors, as discussed above. Specifically, sensors may be used to detect black toner area concentration. Alternatively, sensors may be used to detect different levels of toner concentration, and to differentiate levels of toner concentration between different colors. The sensed data may be used to determine whether a target lead edge corresponds to a written lead edge of the developed image patch following toner image transfer.

If sensing step S400 yields a difference between the target lead edge and the written lead edge, measurement input step S500 may input the sensed difference into a program to cause realignment of the media adjusting various transfer parameter. Such parameters may include, but certainly are not limited to, adjusting the position of the media on the media transfer belt, or adjusting other parameters affecting speed of carriage of the media on the transfer belt into the transfer region, etc. The sensing step S400 and measurement input step S500 may rely not only on the position of a paper lead edge, but also side edges or a tail edge of a paper sheet or other acceptable media. This will allow for registration of a media, and also adjustment for skew or other misalignment.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for media registration setup in an image recognition device having a photoreceptor, the photoreceptor having a plurality of image panels wherein at least two image panels are arranged adjacent to one another, each image panel having an edge, the method comprising:
depositing a developed image patch on the photoreceptor surface;
carrying a media sheet to a transfer region, the transfer region being defined by the photoreceptor and a transfer belt, the media sheet having an edge;
transferring toner particles by applying an electric field to the media sheet;
sensing a written edge of the image patch;
judging alignment of the media sheet by determining a location of the written edge, which corresponds to the media sheet edge, relative to a target edge; and
adjusting alignment of the media sheet edge based on the judged alignment to effect overlap of the written edge with the target edge.

2. The method of claim 1, the sensing the written edge further comprising detecting toner area concentration.

3. The method of claim 1, the sensing the written edge further comprising differentiating between a plurality of toners to detect a toner concentration of each of the plurality of toners.

4. The method of claim 1, the sensing the written edge further comprising determining a border of a high density residual toner image region of the image patch and low density residual toner image region of the image patch, the border corresponding to the written edge.

5. The method of claim 1 wherein the edge of the sheet is a lead edge or a trail edge.

6. An apparatus for media registration setup in an image recognition device having a photoreceptor, the photoreceptor having a plurality of image panels with at least two adjacent image panels, the photoreceptor being constructed to carry developed image toner particles; a media transfer belt, whereby the transfer belt carries a media sheet in contact with the photoreceptor, the photoreceptor and transfer belt arranged proximally to define a transfer region; and a charge roll applying electrostatic field to the media sheet in the transfer region to effect a transfer field to accommodate transfer of an amount of image toner particles, the apparatus comprising:
sensors for sensing a border of a high density and a low density residual toner image on the image panel to deduce a location of a written edge of the image patch corresponding to an edge of the media sheet; and
a media registration adjustment controller to ensure that the written edge corresponds to a target edge on the photoreceptor.

7. The apparatus for media registration setup in the image recognition device of claim 6, wherein the sensors are ETAC sensors for sensing toner area concentration.

8. The apparatus for media registration setup in the image recognition device of claim 6, wherein the sensors are BTAC sensors for sensing toner area concentration.

9. The apparatus for media registration setup in the image recognition device of claim 6, wherein the edge of the media sheet is a lead edge.

10. The apparatus for media registration setup in the image recognition device of claim 6, wherein the edge of the media sheet is a trail edge.

11. The apparatus for media registration setup in the image recognition device of claim 6, wherein the edge of the media sheet is a side edge.

12. A system for media registration setup in an image recognition device having a photoreceptor arranged proximally to an image transfer belt, the photoreceptor having a plurality of image panels, at least two of the image panels being adjacent to one another, the transfer belt constructed to carry a media sheet to a transfer region defined by the photoreceptor and the transfer belt and arranged to accommodate application of an electric field, the image recognition device further having a plurality of sensors arranged about the photoreceptor, the system comprising:
means for depositing on a surface of the photoreceptor a developed image patch that overlaps at least two of the image panels;
means for applying an electric field to the media sheet as the media sheet passes through the transfer region to effect toner image transfer; and
means for sensing a residual image toner density to deduce the location of a written edge relative to a target edge on the photoreceptor surface.

13. The system of claim 12, the means for sensing a residual image toner density comprising detecting toner area concentration.

14. The system of claim 12, the means for sensing a residual image toner density comprising differentiating between a plurality of toners to detect a toner concentration of each of the plurality of toners.

15. The system of claim 12, the means for sensing a residual image toner density comprising determining a border of a high density residual toner image region of the image patch and low density residual toner image region of the image patch, the border corresponding to the written edge.
